(19) United States
(12) Patent Application Publication
(10) Pub. No.: US 2026/0195303 A1
(43) Pub. Date: Jul. 9, 2026

(54) DATABASE MANAGEMENT DEVICE, DATABASE MANAGEMENT METHOD ANDDATABASE MANAGEMENT PROGRAM

(71) Applicant: NTT, Inc., Tokyo (JP)

(72) Inventor: Yasuo KATAOKA, Tokyo (JP)

(73) Assignee: NTT, Inc., Tokyo (JP)

(21) Appl. No.: 18/863,756

(22) PCT Filed: May 10, 2022
(86) PCT No.: PCT/JP2022/019839

§ 371 Date: Nov. 7, 2024

(51) Int. Cl. G06F 16/21; G06F 16/28; G06F 16/901

(52) U.S. Cl. CPC G06F 16/212; G06F 16/288; G06F 16/9024

(57) ABSTRACT

In a database management device (10), an acquisition unit (15a) is configured to acquire, for each node, information on attributes of a node including information for identifying a layer to which the node belongs, and information indicating a relationship between nodes. A configuration unit (15b) is configured to configure a graph DB (14a) in which the acquired information on attributes of each node is associated with the information indicating a relationship between nodes.

### TECHNICAL FIELD

The present invention relates to a database management device, a database management method, and a database management program.

### BACKGROUND ART

A graph database (graph DB) capable of acquiring a connection relationship between data at a higher speed has drawn attention in development of information systems (see Patent Literatures 1 and 2). The graph DB is a database using graph structures of nodes (data points) and relationships (edges) between two nodes.

### CITATION LIST

### Patent Literature

Patent Literature 1: JP H6-203072 A
Patent Literature 2: JP 2016-51262 A

### SUMMARY OF INVENTION

### Technical Problem

However, the conventional technology has unsolved challenges that, when a plurality of nodes constitute a layer in the graph DB, it is unable to directly define which layer each node belongs to, and thus a hierarchical structure is unclear. Therefore, it is difficult to identify the schema and hierarchal structure of the database, which hinders full understanding of database developers and users for the database definition.

The present invention has made to address such problems, and an object thereof is to enable database developers and users to easily understand an internal structure of a graph DB.

### Solution to Problem

For solving the foregoing problem and achieving the object, a database management device according to the present invention is a database management device including: an acquisition unit configured to acquire, for each node, information on attributes of a node including information for identifying a layer to which the node belongs, and information indicating a relationship between nodes; and a configuration unit configured to configure a database in which the acquired information on attributes of each node is associated with the information indicating a relationship between nodes.

### Advantageous Effects of Invention

According to the present invention, database developers and users can easily understand the internal structure of a graph DB.

### BRIEF DESCRIPTION OF DRAWINGS

FIG. 1 is a diagram illustrating an outline of a database management device.

FIG. 2 is a schematic diagram illustrating an outline configuration of the database management device.

FIG. 3 is a diagram illustrating processing executed by a configuration unit.

FIG. 4 is a flowchart illustrating a database management processing procedure.

FIG. 5 is a diagram illustrating a computer that executes a database management program.

### DESCRIPTION OF EMBODIMENTS

Hereinafter, one embodiment of the present invention will be described in detail with reference to the drawings. Note that the present invention is not limited to this embodiment. The same reference symbols are assigned to the same components in the description of the drawings.

### Outline of Database Management Device

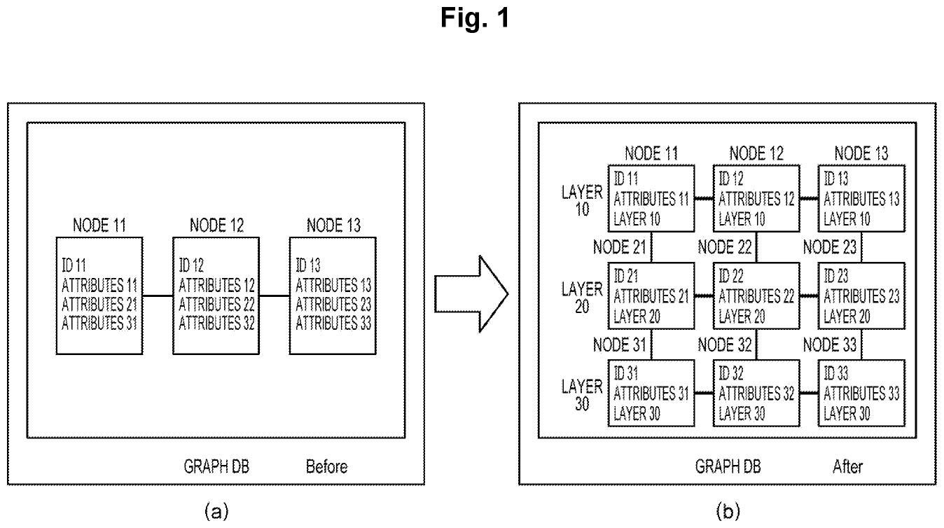

FIG. 1 is a diagram illustrating an outline of a database management device. As illustrated in FIG. 1(a), a graph DB is generally described by nodes and a relationship between two nodes. FIG. 1(a) illustrates that, for example, an “ID 11” as ID and “attributes 11”, “attributes 21” and “attributes 31” as attributes are assigned to a node called “node 11”. A relationship between the node 11 and a node 12, and a relationship between the node 12 and a node 13 are represented by edges.

However, a hierarchical structure between nodes, if any, cannot be clearly recognized by the representation as shown in FIG. 1(a). Therefore, the database management device according to the present embodiment assigns a layer number to attributes of each node as illustrated in FIG. 1(b). In FIG. 1(b), for example, a layer number “layer 10” is assigned to the node 11.

In the example illustrated in FIG. 1(b), there are three layers between nodes that are numbered “layer 10”, “layer 20” and “layer 30”, respectively, and for example, the layer 10 includes the nodes 11, 12 and 13. In other words, it is possible to represent a graph DB having a hierarchical structure between nodes by assigning a layer number to the attributes of each node.

As described above, according to the database management device of the present embodiment, it is possible to clarify the hierarchical structure in the internal representation of the graph DB and to enable optimal description of relationship between nodes. Accordingly, DB developers can experience improved development efficiency. Further, DB users can enjoy speeded-up outputs of the graph DB based on the search from applications.

### Configuration of Database Management Device

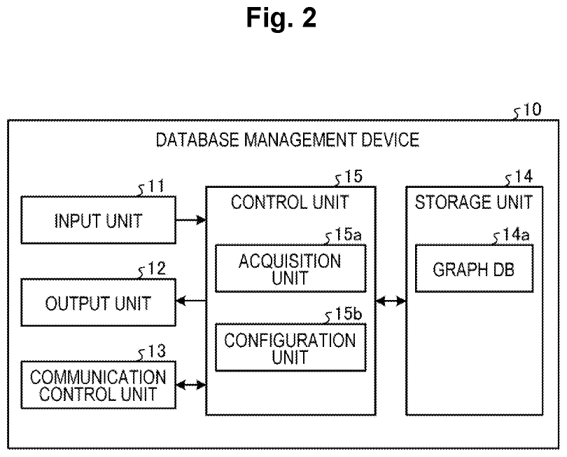

FIG. 2 is a schematic diagram illustrating an outline configuration of the database management device. As illustrated in FIG. 2, a database management device 10 is implemented by a general-purpose computer such as a personal computer, and includes an input unit 11, an output unit 12, a communication control unit 13, a storage unit 14, and a control unit 15.

The input unit 11 is implemented by using an input device such as a keyboard or a mouse and inputs various types of instruction information such as initiation of a process to the control unit 15 in response to an input operation of an operator. The output unit 12 is implemented by a display device such as a liquid crystal display or a printing device, e.g. printer.

The communication control unit 13 is implemented by, for example, a network interface card (NIC), and controls communication between an external device such as a server and the control unit 15 via a network. For example, the communication control unit 13 controls communication between the control unit 15 and a database device of another system that manages data used for database management processing to be described below, or a user terminal in which an application is installed.

The storage unit 14 is implemented by a semiconductor memory element such as a random access memory (RAM) or a flash memory, or a storage device such as a hard disk or an optical disc. In the storage unit 14, a processing program for operating the database management device 10, and data to be used during execution of the processing program are stored in advance or temporarily stored each time processing is performed. The storage unit 14 may be configured to have communication with the control unit 15 via the communication control unit 13.

In the present embodiment, a graph DB 14a generated by the database management processing to be described later is stored in the storage unit 14, and used as a database by the applications.

The control unit 15 is implemented by using, for example, a central processing unit (CPU) and executes a processing program stored in the memory. Accordingly, the control unit 15 functions as an acquisition unit 15a and a configuration unit 15b, and executes the database management processing to be described later, as illustrated in FIG. 2. Each of these functional units may be implemented in different hardware. Moreover, the control unit 15 may include other functional units.

The acquisition unit 15a is configured to acquire, for each node, information on attributes of a node including information for identifying a layer to which the node belongs, and information indicating a relationship between nodes. For example, the acquisition unit 15a acquires data used for processing of the configuration unit 15b to be described later via the input unit 11 or from a database device of another system via the communication control unit 13.

The configuration unit 15b is configured to configure a database in which the acquired information on attributes of each node is associated with the information indicating a relationship between nodes. Specifically, the configuration unit 15b configures a database by associating attribute information of each node with information indicating a relationship between nodes, and stores the database in the storage unit 14 as the graph DB 14a.

The acquired attribute information of the node includes information such as a layer number for identifying a layer to which the node belongs. Therefore, as illustrated in FIG. 1(b), layer numbers for identifying a layer to which each node belongs is assigned to the graph DB 14a. Accordingly, it is possible to describe the graph DB having a hierarchical structure between nodes. Therefore, the layer constituted by the plurality of nodes of the graph DB 14a becomes clear.

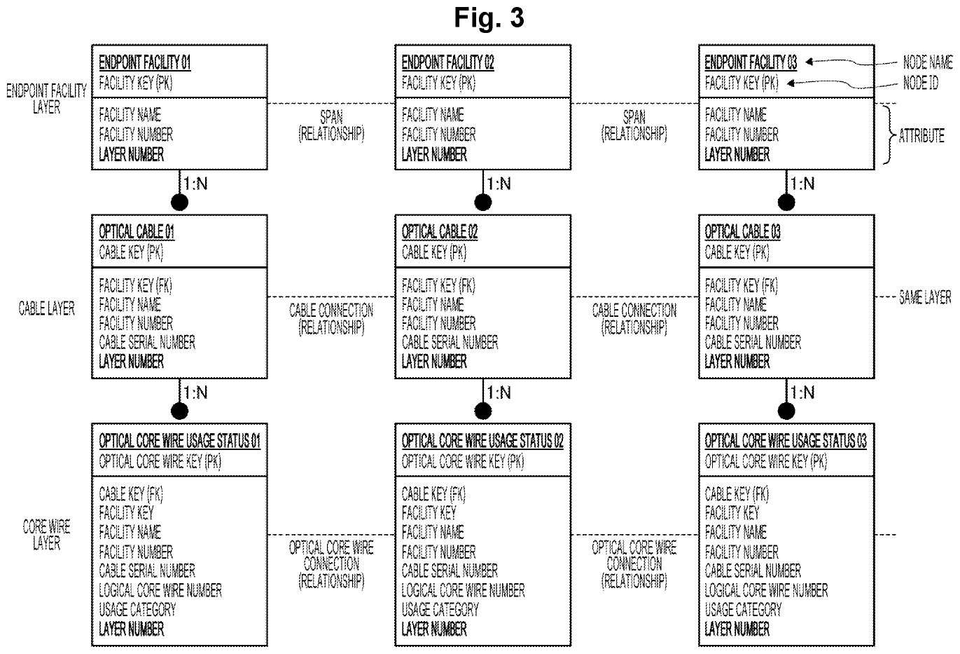

FIG. 3 is a diagram illustrating processing executed by the configuration unit. FIG. 3 illustrates a configuration of the graph DB 14a in a case where a communication facility is a node. As illustrated in FIG. 3, for example, the node is a communication facility, and the layer is a layer in a network of the communication facility.

In the graph DB 14a in this case, each of endpoint facilities 01 to 03, optical cables 01 to 03, and optical core wire usage statuses 01 to 03 is set as a node, and attribute information is described for each node. Each node includes a node name, a node ID, and attribute information. The attribute information includes a layer number, a facility name and a facility number.

In the graph DB 14a, relationships such as a span, cable connection, and optical core wire connection are described as information indicating a relationship between nodes.

The layer number is information for identifying a layer configured by nodes. In the example illustrated in FIG. 3, three layers of an endpoint facility layer, a cable layer, and a core layer are configured between nodes, and the nodes in the same layer are connected by a broken line. For example, the endpoint facility layer includes endpoint facilities 01 to 03. As the layer number for the endpoint facilities 01 to 03, information for identifying the endpoint facility layer is set.

Alternatively, the node may be an organization in an enterprise, and the layer may be a tier of the organization in a chain of command of the enterprise. In this case, the attribute information of the node includes, for example, personnel information of employees belonging to each organization, and information of products and services provided by each organization. This attribute information includes layer numbers assigned in ascending order in the order of affiliates, branch offices and sales offices, with the president and the head office as the first tier. By configuring the database as above, the layer configured by the plurality of nodes in the graph DB 14a is clarified.

### Database Management Processing

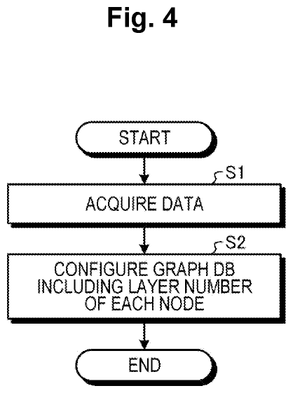

Database management processing by the database management device 10 according to the present embodiment will be described with reference to FIG. 4. FIG. 4 is a flowchart illustrating a database management processing procedure. The flowchart of FIG. 4 is started, for example, at a timing when operation input is performed for giving an instruction to initiate the database management processing.

The acquisition unit 15a acquires, for each node, information on attributes of a node including information for identifying a layer to which the node belongs, and information indicating a relationship between nodes (step S1). For example, the acquisition unit 15a acquires data used for processing of the configuration unit 15b to be described later via the input unit 11 or from a database device of another system via the communication control unit 13.

Next, the configuration unit 15b configures a database in which the acquired information on attributes of each node is associated with the information indicating a relationship between nodes (step S2). Specifically, the configuration unit 15b configures a database by associating attribute information of each node with information indicating a relationship between nodes, and stores the database in the storage unit 14 as the graph DB 14a. A series of steps of the database management processing ends.

### Advantageous Effects

As described above, in a database management device 10, the acquisition unit 15a acquires, for each node, information on attributes of a node including information for identifying a layer to which the node belongs, and information indicating a relationship between nodes. The configuration unit 15b configures the graph DB 14a in which the acquired information on attributes of each node is associated with the information indicating a relationship between nodes.

Specifically, for example, the node is a communication facility, and the layer is a layer in a network of the communication facility. Alternatively, the node may be an organization in an enterprise, and the layer may be a tier of the organization in a chain of command of the enterprise.

As described above, according to the database management device 10 of the present embodiment, it is possible to clarify the hierarchical structure in the internal representation of the graph DB 14a and to enable optimal description of relationship between nodes, even if the graph DB 14a becomes extremely complicated. Accordingly, DB developers can experience improved development efficiency. Further, DB users can enjoy speed-up outputs of the graph DB 14a based on the search from applications.

### Program

It is also possible to create a program that describes the processing executed by the database management device 10 according to the above embodiment in a computer executable language. As one embodiment, it is possible to implement the database management device 10 by installing a database management program for executing the database management processing described above as package software or online software in a desired computer. For example, it is possible to allow an information processing device to function as the database management device 10 by causing the information processing device to execute the database management program described above. Additionally, the information processing device includes a mobile communication terminal such as a smartphone, a mobile phone or a personal handyphone system (PHS), as well as a slate terminal such as a personal digital assistant (PDA). The function of the database management device 10 may be implemented in a cloud server.

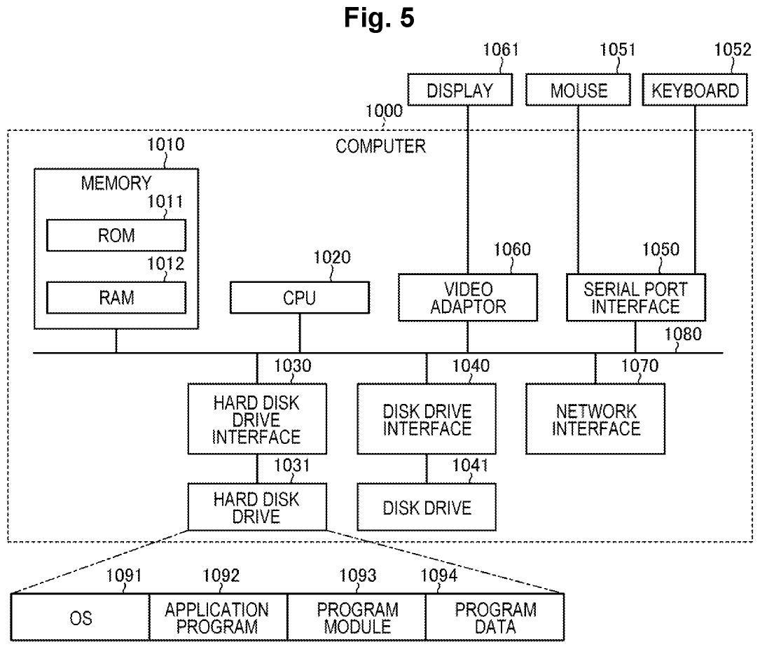

FIG. 5 is a diagram illustrating one example of a computer that executes the database management program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a read-only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1051 and a keyboard 1052. The video adapter 1060 is connected to, for example, a display 1061.

The hard disk drive 1031 stores, for example, an OS 1091, an application program 1092, a program module 1093, and program data 1094. Each piece of information described in the above embodiment is stored in, for example, the hard disk drive 1031 or the memory 1010.

The database management program is stored in the hard disk drive 1031 as, for example, a program module 1093 in which a command executed by the computer 1000 is described. Specifically, the program module 1093 in which each set of processing executed by the database management device 10 described in the above embodiment is stored in the hard disk drive 1031.

Data used for information processing by the database management program is stored as the program data 1094, for example, in the hard disk drive 1031. The CPU 1020 reads into the RAM 1012 the program module 1093 and the program data 1094 stored in the hard disk drive 1031 as necessary and executes each procedure described above.

Note that the program module 1093 and the program data 1094 related to the database management program are not limited to being stored in the hard disk drive 1031, and may be stored in, for example, a removable storage medium and read by the CPU 1020 via the disk drive 1041. Alternatively, the program module 1093 and the program data 1094 related to the database management program may be stored in another computer connected via a network such as a local area network (LAN) or a wide area network (WAN) and may be read by the CPU 1020 via the network interface 1070.

Although the embodiments to which the present invention made by the present inventors is applied have been described above, the present invention is not limited to the description and the drawings which constitute parts of the disclosure of the embodiment of the present invention. In other words, other embodiments, examples and operations made by those skilled in the art on the basis of the present embodiment are all encompassed in the scope of the present invention.

### REFERENCE SIGNS LIST

10 Database management device
11 Input unit
12 Output unit
13 Communication control unit
14 Storage unit
14a Graph DB
15 Control unit
15a Acquisition unit
15b Configuration unit

1. A database management device comprising:
an acquisition unit configured to acquire, for each node, information on attributes of a node including information for identifying a layer to which the node belongs, and information indicating a relationship between nodes; and
a configuration unit configured to configure a database in which the acquired information on attributes of each node is associated with the information indicating a relationship between nodes.

2. The database management device according to claim 1, wherein the node is a communication facility, and the layer is a layer in a network of the communication facility.

3. The database management device according to claim 1, wherein the node is an organization in an enterprise, and the layer is a tier of the organization in a chain of command of the enterprise.

4. A database management method executed by a database management device, the database management method comprising:
acquiring, for each node, information on attributes of a node including information for identifying a layer to which the node belongs, and information indicating a relationship between nodes; and
configuring a database in which the acquired information on attributes of each node is associated with the information indicating a relationship between nodes.

5. A database management program for causing a computer to execute:
acquiring, for each node, information on attributes of a node including information for identifying a layer to which the node belongs, and information indicating a relationship between nodes; and
configuring a database in which the acquired information on attributes of each node is associated with the information indicating a relationship between nodes.
